(19) United States
(12) Patent Application Publication
(10) Pub. No.: US 2011/0037664 A1
(43) Pub. Date: Feb. 17, 2011

(54) BUILT-IN ANTENNA MODULE IN PORTABLE WIRELESS TERMINAL

(75) Inventors: Young-Jun CHO, Gyeonggi-do (KR); Byoung-Man LIM, Seoul (KR); Austin KIM, Gyeonggi-do (KR); Yong-Jin KIM, Seoul (KR); Jae-Ho LEE, Gyeonggi-do (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/849,339

(22) Filed: Aug. 3, 2010

(30) Foreign Application Priority Data
Aug. 11, 2009 (KR) 10-2009-0073622

(51) Int. Cl. H01Q 1/24

(52) U.S. Cl. 343/702

(57) ABSTRACT

A built-in antenna module of a portable wireless terminal includes an antenna radiator, electrically connected to a main board, for transmitting and receiving a signal of a specific frequency band, and at least one unit fixed to a specific structural member and electrically connected to the main board by means of a Flexible Printed Circuit Board (FPCB), wherein the antenna radiator is implemented integrally with the FPCB.

### CLAIM OF PRIORITY

This application claims the benefit under 35 U.S.C. §119(a), to that patent application, entitled BUILT-IN ANTENNA MODULE IN PORTABLE WIRELESS TERMINAL, filed in the Korean Intellectual Property Office on Aug. 11, 2009 and assigned Serial No. 10-2009-0073622, the contents of which are incorporated by reference in its entirety, herein.

### BACKGROUND OF THE INVENTION

1. Field of the Invention

The present invention relates to a built-in antenna module embedded in a portable wireless terminal. More particularly, the present invention relates to a built-in antenna module for a portable wireless terminal configured to improve the manufacturing process and reduce the required number of components, thus yielding a lighter and thinner terminal.

2. Description of the Related Art

Recently, as portable wireless terminals such as a Personal Communication System (PCS), a Digital Communication System (DCS), a Global Positioning System (GPS), a Personal Digital Assistant (PDA), a cellular phone, a wireless laptop computer, etc., have become widespread in usage, terminals are introduced with various functions and designs. In addition, while small, light, thin, and simple terminals are becoming trend, functions of the terminals are more critical. To satisfy ever growing customers' demands, it is important to reduce the size of the terminal while maintaining or improving the functions of the terminal.

Regarding an antenna, a rod antenna (or a whip antenna) and a helical antenna which protrude outwardly by a specific length from the terminal are most susceptible to drop damage. Their size also causes a problem in reducing portability of the terminal. Therefore, a built-in antenna (i.e., so called an ‘internal antenna’ or an ‘antenna’) installed inside the terminal is widely used in recent years. Various efforts have been made to improve a characteristic of the built-in antenna also in order to improve assembly capability and productivity.

A built-in antenna is typically constructed of an antenna radiator and a specific non-conductive antenna carrier for fixing the antenna radiator, and is electrically connected to a main board, i.e., a Radio Frequency (RF) board of a main body. In the built-in antenna module, a speaker and a vibrator which are necessary elements of the terminal are included in the extra space of the antenna carrier.

However, the built-in antenna is manufacturing process as stated above results in the increase of the number of manufacturing processes and a unit cost.

### SUMMARY OF THE INVENTION

The present invention provides a built-in antenna module of a portable wireless terminal configured to realize a light, thin, and simple terminal while reducing a unit cost by decreasing the number of manufacturing processes.

According to an aspect of the present invention is to provide a built-in antenna module of a portable terminal capable of increasing efficiency of a manufacturing process by integrally implementing an antenna radiator fixed to a specific structural member with a Flexible Printed Circuit Board (FPCB) for connecting units thereto.

According to another aspect of the present invention is to provide a built-in antenna module of a portable wireless terminal configured to readily ensure the space for installing the terminal by integrally implementing a speaker and/or a vibrator and an antenna radiator into one module.

In accordance with an aspect of the present invention, a built-in antenna module of a portable wireless terminal includes an antenna radiator, electrically connected to a main board, for transmitting and/or receiving (transceiving) a signal of a specific frequency band, and at least one unit fixed to a specific structural member and electrically connected to the main board by means of an FPCB, wherein the antenna radiator is implemented integrally with the FPCB.

### BRIEF DESCRIPTION OF THE DRAWINGS

The above and other exemplary objects, features and advantages of the present invention will be more apparent from the following detailed description taken in conjunction with the accompanying drawings in which:

FIG. 1 is a perspective view of a portable wireless terminal having a built-in antenna module according to an exemplary embodiment of the present invention;

FIG. 2 is a perspective view of a built-in antenna module according to an exemplary embodiment of the present invention; and

FIG. 3 is a schematic view illustrating a structure of a built-in antenna module according to another exemplary embodiment of the present invention.

Throughout the drawings, like reference numerals will be understood to refer to like parts, components and structures.

### DETAILED DESCRIPTION

The following description, with reference to the accompanying drawings, is provided to assist a person of ordinary skill in the art with a comprehensive understanding of exemplary embodiments of the present invention as defined by the claims. The description includes various specific details to assist in that understanding, but these details are to be regarded as merely exemplary. Accordingly, those of ordinary skill in the art will recognize that various changes and modifications of the exemplary embodiments described herein can be made without departing from the scope and spirit of the invention as defined by the appended claims. For the purposes of clarity and simplicity, descriptions of well-known functions and constructions may be omitted not to obscure appreciation of the present invention by a person of ordinary skill with such well-known functions and constructions.

The terms and words used in the following description and claims are not limited to the bibliographical meanings, but, are merely used by the inventor to enable a clear and consistent understanding of the invention as understood by a person of ordinary skill in the art. Accordingly, it should be apparent to those skilled in the art that the following description of exemplary embodiments of the present invention are provided for illustration purpose only and not for the purpose of limiting the invention as defined by the appended claims.

It is to be understood that the singular forms “a”, “an”, and “the” include plural references unless the context clearly dictates otherwise. Thus, for example, reference to “a component surface” typically includes reference to one or more of such surfaces.

By the term “substantially” typically means that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The present invention relates to a built-in antenna module. In particular, the present invention integrally implements an antenna radiator readily fixed to an antenna carrier when implementing a Flexible Printed Circuit Board (FPCB) for connecting units, which are constructed inside the antenna carrier or fixed to another structural member, to a main board, thereby decreasing the number of manufacturing processes. As a result, a unit cost may be decreased and efficiency may be increased.

Hereinafter, exemplary embodiments of the present invention will be described in detail with reference to the accompanying drawings. Although a slide type terminal is illustrated in describing the present invention, the present invention is not limited thereto. The teachings of the present invention may apply to various types (e.g., a folder type, a bar type, a flip type, a flip-up type, etc.,) of terminals having a built-in antenna module.

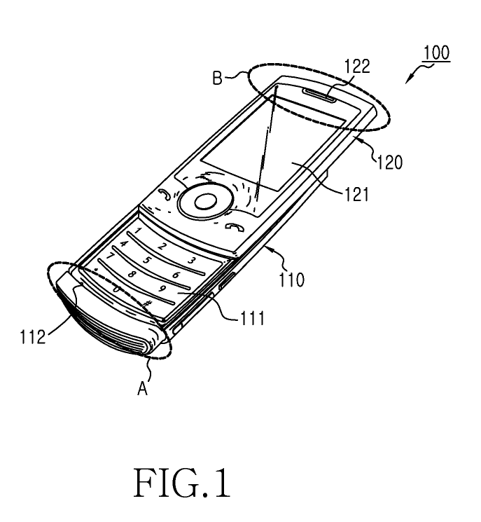

FIG. 1 is a perspective view of a portable wireless terminal having a built-in antenna module according to an exemplary embodiment of the present invention.

As shown in FIG. 1, a terminal 100 using a built-in antenna module includes a main body 110 and a sub body 120 slidable over the main body 110 to open and close. The main body 110 is installed with a key pad assembly 111 including navigation key buttons as a data input element, and a microphone unit 112 below the key pad assembly 111 for transmitting a voice signal to a recipient.

The sub body 120 is installed with a display unit 121 and a speaker unit 122 above the display unit 121 for receiving voice signals of the recipient.

The terminal 100 according to the exemplary embodiment of the present invention employs a built-in antenna module equipped, thus an antenna apparatus protruding outwardly g from the main is absent. The built-in antenna module may be installed in a portion A or a portion B indicated by a broken line of FIG. 1. In addition to the microphone unit 112, an additional speaker or vibrator may be installed in the portion A.

It is assumed in the following description that the built-in antenna module installed in the portion A or the portion B of FIG. 1 includes the speaker and the vibrator. However, the present invention is not limited thereto, and thus the built-in antenna module may include at least other unit in association with the terminal.

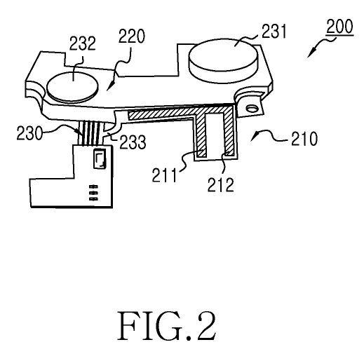

FIG. 2 is a perspective view of a built-in antenna module 200 according to an exemplary embodiment of the present invention.

As shown in FIG. 2, the built-in antenna module 200 includes an antenna radiator 210 for transmitting and/or receiving (transceiving) a signal of a corresponding frequency band and a non-conductive antenna carrier 220 for fixing the antenna radiator 210. The built-in antenna module 200 is electronically connected to a main board (not shown).

The antenna radiator 210 is mounted on the antenna carrier 220. Then the antenna carrier 220 having the antenna radiator 210 is mounted on the main board and thereby maintaining a distance between the antenna radiator 210 and the main board to a specific distance.

In addition, the antenna carrier 220 may include a speaker 231 and a vibrator 232 in the inner space. This configuration contributes elements of the terminal to meet the light and thin trend. The speaker 231 and the vibrator 232 are electrically connected to the main board by means of a Flexible Printed Circuit Board (FPCB) 230.

The antenna radiator 210 has a specific radiation pattern capable of transmitting and/or receiving a signal of a specific frequency band. During a manufacturing process, the antenna radiator 210 is integrated with the FPCB 230 by being branched off from the FPCB 230. The antenna radiator 210 is a flexible metal thin plate (e.g., a copper thin plate) which is light and thin that can be freely distorted and bent, thereby facilitating a manufacturing process. Further, the antenna radiator 210 is connected to the FPCB 230 by using a non-conductive flexible resin 233 and thus may be freely bent. For example, the antenna radiator 210 may be distorted or bent so as to be fixed to the antenna carrier 220. An adhesive member such as a double-sided tape, an adhesive material, etc., may be used as a means for fixing the antenna radiator 210 to the antenna carrier 220.

Alternatively, if the speaker 231 and the vibrator 232 are fixed to a case frame that defines an outer surface of the terminal, the antenna carrier 220 may be unnecessary.

The antenna radiator 210 includes two pins 211 and 212 electrically connected to the main board to transmit and/or receive a signal. The pin 211 may be a power feeding pin electrically connected to a power feeding portion of the main board. The pin 212 may be a ground pin connected to a ground portion (or a ground) of the main board.

Preferable, the built-in antenna module 200 according to the embodiment of the present invention may be implemented with a mono-pole and Planner Inverted F Antenna (PIFA) type or a loop type.

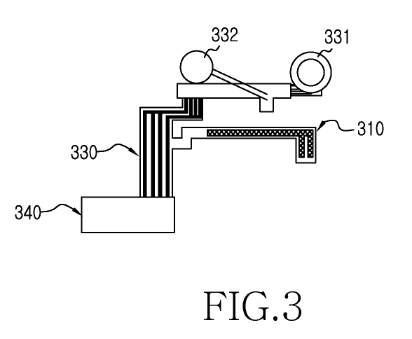

FIG. 3 is a schematic view illustrating a structure of a built-in antenna module 300 according to another exemplary embodiment of the present invention.

As shown in FIG. 3, a speaker 331 and a vibrator 332 are disposed in the aforementioned antenna carrier, and are electrically connected to a main board by means of an FPCB 330. One end of the FPCB 330 is connected to the speaker 331 and the vibrator 332. The other end of the FPCB 330 may include a Printed Circuit Board (PCB) 340 including a connector socket for communication with the main board. An antenna radiator 310 fixed to the antenna carrier and having a specific radiation pattern is designed integrally with the FPCB 330.

Similar to the earlier embodiment shown in FIG. 2, the built-in antenna module according to the second the present invention may decrease the number of manufacturing processes by integrally implementing the antenna radiator readily fixed to the antenna carrier when implementing the FPCB for connecting specific units to the main board, thereby decreasing a unit cost and increasing efficiency.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. A built-in antenna module of a portable wireless terminal, comprising:
an antenna radiator, electrically coupled to a main board, for transmitting and receiving a signal of a specific frequency band; and
at least one unit fixed to a specific structural member and electrically coupled to the main board by means of a Flexible Printed Circuit Board (FPCB),
wherein the antenna radiator is implemented integrally with the FPCB.

2. The built-in antenna of claim 1, wherein the structural member is an antenna carrier for fixing the antenna radiator.

3. The built-in antenna of claim 1, wherein the structural member is a case frame for defining an outer surface of the terminal.

4. The built-in antenna of claim 1, wherein the unit is at least one of a speaker and a vibrator.

5. The built-in antenna of claim 1, wherein the antenna radiator is attached to the structural member by using any one of a double-sided tape and an adhesive material.

6. The built-in antenna of claim 1, wherein the antenna radiator is a copper thin plate having a specific radiation pattern.

7. The built-in antenna of claim 1, wherein the antenna radiator comprises a power feeding pin coupled to a power feeding portion of the main unit and a ground pin coupled to a ground portion of the main board.

8. The built-in antenna of claim 1, wherein the antenna radiator and the FPCB are mutually insulated.

9. The built-in antenna of claim 1, wherein the antenna radiator is an FPCB type.

10. The built-in antenna of claim 1, wherein the antenna radiator is coupled to the FPCB using a non-conductive flexible resin.

11. The built-in antenna of claim 1, wherein the built-in antenna module is a mono-pole, a Planner Inverted F Antenna (PIFA), or a loop type.

12. The built-in antenna of claim 1, wherein the built-in antenna is installed on an upper or lower portion of the portable wireless terminal.

13. A process of manufacturing a radiator of a built-in antenna, comprising:
providing an antenna radiator, electrically coupled to a main board, for transmitting and receiving a signal of a specific frequency band; and
providing an antenna carrier coupled to the antenna radiator and electrically coupled to the main board by means of a Flexible Printed Circuit Board (FPCB),

14. The process of claim 13, wherein the antenna radiator is insulated from another FPCB.

15. The process of claim 13, further comprising at least one of a speaker and a vibrator coupled to the antenna carrier.

16. The process of claim 13, wherein the antenna radiator is coupled to the antenna carrier by using any one of a double-sided tape and an adhesive material.

17. The process of claim 13, wherein the antenna radiator is a copper thin plate having a specific radiation pattern.

18. The process of claim 13, wherein the antenna radiator comprises a power feeding pin coupled to a power feeding portion of the main unit and a ground pin coupled to a ground portion of the main board.

19. The process of claim 13, wherein the antenna radiator and the FPCB are mutually insulated.

20. The process of claim 13, wherein the antenna radiator is coupled to the FPCB using a non-conductive flexible resin.

21. The process of claim 13, wherein the antenna radiator integrally extends from the FPCB.
